(19) United States
(12) Patent Application Publication
(10) Pub. No.: US 2013/0169725 A1
(43) Pub. Date: Jul. 4, 2013

(54) MEDIA CONVEYANCE DEVICE AND PRINTING DEVICE

(71) Applicants: Hiroshi HAMAKAWA, Matsumoto-shi (JP); Tetsugo Ishida, Shiojiri-shi (JP)

(72) Inventors: Hiroshi HAMAKAWA, Matsumoto-shi (JP); Tetsugo Ishida, Shiojiri-shi (JP)

(73) Assignee: SEIKO EPSON CORPORATION, Tokyo (JP)

(21) Appl. No.: 13/584,264

(22) Filed: Aug. 13, 2012

(30) Foreign Application Priority Data
Aug. 11, 2011 (JP) 2011175650

(51) Int. Cl. B41J 13/02

(52) U.S. Cl. CPC B41J 13/02
USPC 347/104; 226/181

(57) ABSTRACT

A printing device has a guide roller that guides a print medium in a conveyance direction; an intersect roller pair that holds the print medium guided by the guide roller between a first roller that rotates on an axis of rotation in the conveyance direction of the print medium and a second roller that rotates on an axis of rotation that intersects the axis of rotation of the first roller; a conveyance roller pair that conveys the print medium held by the intersect roller pair in the conveyance direction by a conveyance drive roller driven by a drive means and a conveyance follower roller that rotates with the conveyance drive roller; and a print unit that prints on the print medium conveyed by the conveyance roller pair.

### BACKGROUND

1. Technical Field

The present invention relates to a media conveyance device and to a printing device.

2. Related Art

Conveyance roller pairs used to convey paper as the recording medium to the recording unit in a recording device typically include a conveyance drive roller that is driven by a drive motor, and a conveyance follower roller that follows the rotation of the conveyance drive roller. In order for the conveyance roller pair to convey the paper to the recording unit straight, the rotational axes of the conveyance drive roller and follower roller are disposed perpendicularly to the conveyance direction as described in Japanese Unexamined Patent Appl. Pub. JP-A-2002-265089.

The paper may also become skewed to the conveyance direction while being conveyed. There are various reasons for this, including frictional resistance from the edge of the conveyed paper sliding against part of the conveyance path, and conveyance starting with the paper skewed to the paper feed unit. To correct this problem of the paper being fed skewed to the conveyance direction, Japanese Unexamined Patent Appl. Pub. JP-A-2007-84227 teaches a method of providing a rocking mechanism to the stationary part of the conveyance follower roller of the conveyance roller pair so that the rotational axis of the follower roller can be slanted relative to the rotational axis of the conveyance drive roller, and applying pressure to the paper in the opposite direction as the direction in which the paper is skewed to the conveyance direction to correct paper skew while conveying the paper to the recording unit.

However, if roll paper is used as the print medium and paper skew produced near the paper feed unit is corrected by providing a conveyance roller pair directly before the recording unit as described in JP-A-2007-84227, the paper may buckle and curve between the paper feed unit and the conveyance roller pair, and the paper may be wrinkled when supplied to the recording unit.

### SUMMARY

A conveyance device and a printing device having the conveyance device according to the present invention correct paper skew between the paper feed unit and the conveyance roller pair, and convey the print medium to the recording unit (print unit) in the desired conveyance direction with little skew even when roll paper is used as the print medium.

To solve at least one of the problems described above, the present invention can be achieved as described below.

A printing device according to one aspect of the invention includes a guide roller that guides a print medium in a conveyance direction; an intersect roller pair that holds the print medium guided by the guide roller between a first roller that rotates on an axis of rotation in the conveyance direction of the print medium and a second roller that rotates on an axis of rotation that intersects the axis of rotation of the first roller; a conveyance roller pair that conveys the print medium held by the intersect roller pair in the conveyance direction by a conveyance drive roller driven by a drive mechanism and a conveyance follower roller that rotates with the conveyance drive roller; and a print unit that prints on the print medium conveyed by the conveyance roller pair.

Preferably, the printing device also has a guide that guides one edge of the print medium in the conveyance direction.

Further preferably, the conveyance roller pair is disposed substantially in a center of the print medium width perpendicular to the conveyance direction; and the intersect roller pair is disposed on a side of the opposite edge of the print medium as the one edge in the conveyance direction.

Sliding friction in the conveyance direction is produced in this aspect of the invention between the print medium held by the intersect roller pair and the second roller. The friction force produced in the opposite direction as the conveyance direction by this sliding friction becomes a rotational moment applied to the print medium in the direction of the center of the print medium at the part where the print medium is held by the conveyance roller pair as the point of application, and urges the one edge of the print medium to the guide. The print medium is thus corrected and held in the desired conveyance direction by the print medium being urged in contact with the guide.

The quality of images recorded on the print medium can also be maintained with high reliability because the print medium can be conveyed in the desired conveyance direction to the recording means by means of a simple set of intersect rollers having two follower rollers disposed with intersecting axes of rotation.

Another aspect of the invention preferably also has a second intersect roller pair that holds the print medium held by the intersect roller pair between a third roller that rotates on an axis of rotation in the conveyance direction of the print medium and a fourth roller that rotates on an axis of rotation that intersects an axis of rotation of the third roller.

By disposing the cylindrical surfaces of the first roller and second roller crosswise to each other and holding the print medium therebetween, variation in the area holding the print medium can be reduced and the print medium can be conveyed consistently even if there is some deviation in the relative positions of the first roller and second roller due to manufacturing differences.

Yet further preferably, the part of the first roller that contacts the print medium is polyacetal, and the part of the second roller that contacts the print medium is stainless steel.

Because the first roller that rotates in the conveyance direction of the print medium urges the print medium in a direction crosswise to the conveyance direction causing an edge of the print medium to contact the guide, reliably pushing the print medium against the guide may not be possible if the frictional resistance with the print medium is great. By making the first roller from polyacetal (POM: polyoxymethylene), the frictional resistance of the surface that contacts the print medium can be reduced, and a low cost first roller that is easy to mold and has sufficient strength for use as a structural member can be achieved.

The second roller is also disposed with the axis of rotation intersecting the conveyance direction of the print medium, and the print medium slides against the second roller. Because the coefficient of friction can be reduced by making the second roller from stainless steel, the print medium slides easily. A second roller that is worn very little by the sliding print medium and is resistant to corrosion can therefore be achieved.

A printing device according to another aspect of the invention preferably also has a pressure mechanism that pushes the print medium to the guide.

By urging the print medium with an urging means in addition to urging the print medium to the guide with the intersect roller pair, this aspect of the invention can reliably convey the print medium in the desired conveyance direction to the recording means.

Another aspect of the invention is a conveyance device for a printing device including an intersect roller pair that holds a conveyed print medium between a first roller that rotates on an axis of rotation in the conveyance direction of the print medium and a second roller that rotates on an axis of rotation that intersects the axis of rotation of the first roller; and a conveyance roller pair that conveys the print medium held by the intersect roller pair in the conveyance direction by a conveyance drive roller driven by a drive mechanism and a conveyance follower roller that rotates with the conveyance drive roller.

Preferably, the conveyance device also has a guide that guides one edge of the print medium in the conveyance direction.

Further preferably, the conveyance roller pair is disposed substantially in a center of the print medium width perpendicular to the conveyance direction; and the intersect roller pair is disposed on a side of the opposite edge of the print medium as the one edge in the conveyance direction.

By conveying the print medium in the desired conveyance direction to the recording means, this aspect of the invention enables recording images with high print quality because the recording position of the recorded images on the print medium can be accurately controlled.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a section view showing the configuration of a printing device according to a first embodiment of the invention.

FIG. 2A shows the conveyance unit of the printing device according to the first embodiment of the invention from the direction of arrow A in FIG. 1.

FIG. 2B is a section view through B-B′ in FIG. 2A.

FIG. 2C is an enlarged view of part D in FIG. 2B and an enlarged section view through C-C′ in FIG. 2A.

FIG. 3 describes the concept of controlling recording paper in the conveyance unit of the printing device according to the first embodiment of the invention.

FIG. 4A is a plan view of the conveyance unit according to a second embodiment of the invention, and FIG. 4B is a plan view of a variation of the second embodiment.

FIG. 5 shows another variation of the urging unit in the second embodiment of the invention.

### DESCRIPTION OF EMBODIMENTS

Preferred embodiments of the present invention are described below with reference to the accompanying figures.

### Embodiment 1

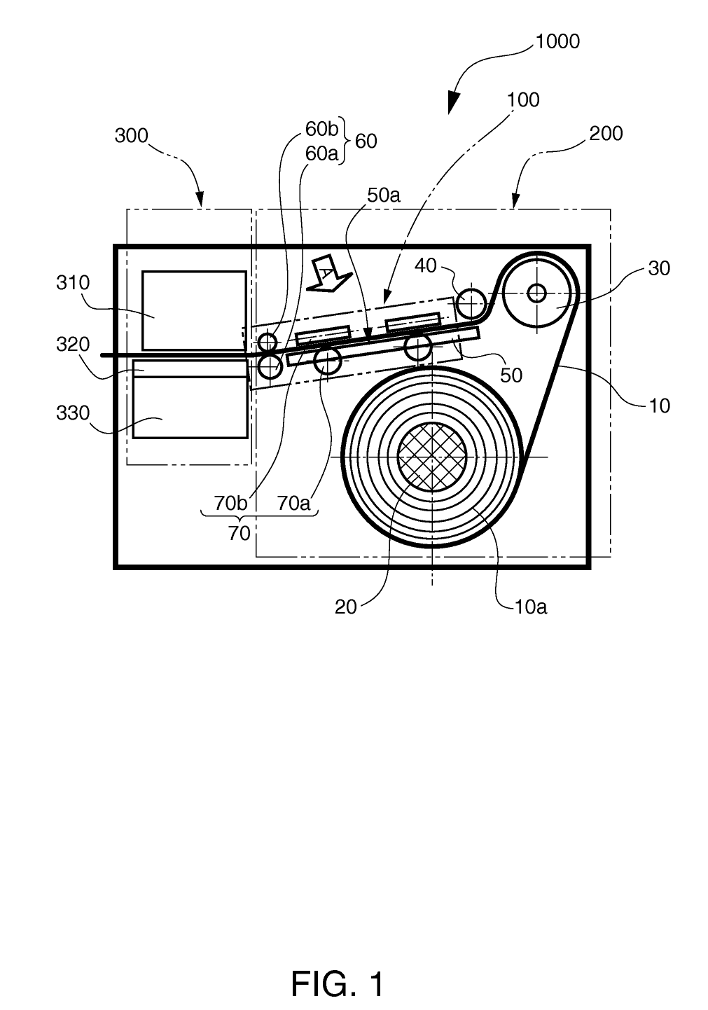

FIG. 1 is a section view showing the configuration of a printing device having a conveyance unit according to a preferred embodiment of the invention. As shown in FIG. 1, the printing device 1000 according to this embodiment has a paper feed unit 200 that stores and supplies recording paper 10 as the print medium to the recording means, and a print unit 300 as a recording means that records specific images to the supplied recording paper 10. The print unit 300 includes a recording unit 310 with an inkjet head, for example, disposed to the recording surface side of the recording paper 10, and a suction mechanism 330 and recording paper suction unit 320 that apply suction to the opposite side of the recording paper 10 as the recording surface to hold the recording paper 10 for recording.

The recording paper 10 is delivered from roll paper 10a stored in a roll in the paper feed unit 200. The roll paper 10a is installed to a roll paper drive shaft 20 that is disposed rotatably to the printing device 1000. The recording paper 10 delivered from the roll paper 10a is conveyed passed the paper feed roller 30 and guide roller 40 to the conveyance unit 100 described as an example of the conveyance device of the invention.

The conveyance unit 100 includes a recording paper support unit 50, conveyance roller pair 60, and a plurality of intersect rollers 70. The recording paper support unit 50 has a recording paper support surface 50a over which the recording paper 10 slides. The conveyance roller pair 60 is located on the print unit 300 side of the recording paper support unit 50. The intersect rollers 70 are disposed in the area of the recording paper support unit 50 between the conveyance roller pair 60 and guide roller 40.

The conveyance roller pair 60 includes a conveyance drive roller 60a that is rotationally driven by a drive means not shown, and a conveyance follower roller 60b that follows rotation of the conveyance drive roller 60a. The recording paper 10 is held between the conveyance drive roller 60a and follower roller 60b.

The intersect rollers 70 include a first roller 70a that follows the conveyance direction of the recording paper 10, and a second roller 70b with an axis of rotation that intersects the axis of rotation of the first roller 70a, and the recording paper 10 is held between the first roller 70a and second roller 70b. The intersect rollers 70 in this embodiment of the invention are configured with the axis of rotation of the second roller 70b substantially perpendicular to the axis of rotation of the first roller 70a. As described below, the angle of intersection between the rotational axes of the first roller 70a and second roller 70b is not specifically limited, but is preferably perpendicular as described in this embodiment.

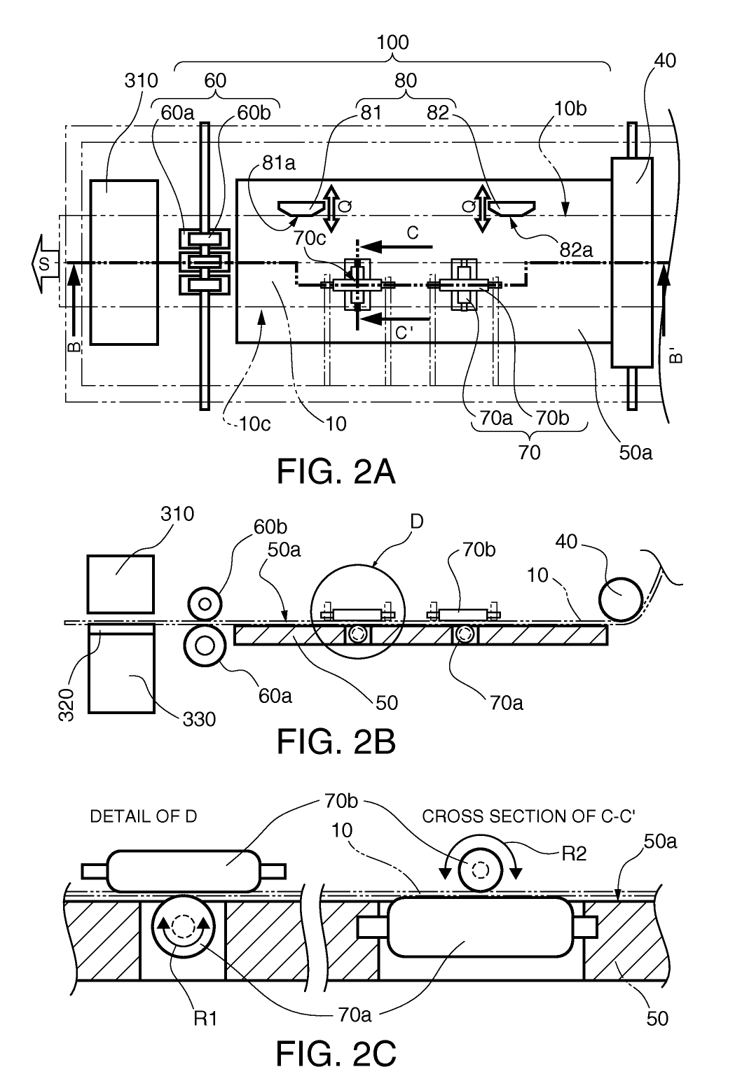

FIG. 2 shows the conveyance unit 100 in detail, FIG. 2A showing the conveyance unit from the direction of arrow A in FIG. 1, and FIG. 2B being a section view through B-B′ in FIG. 2A. FIG. 2C is an enlarged view of part D in FIG. 2B and an enlarged section view through C-C′ in FIG. 2A. As shown in FIG. 2A, a guide 80 is disposed to the recording paper support unit 50 of the conveyance unit 100. This guide 80 has a first stop 81 and a second stop 82 that stop the edge 10b of one side of the recording paper 10 relative to the width of the conveyance direction S. The guide 80 can be moved in direction Q, which is the direction across the width of the recording paper 10, by a moving means not shown, and the center of the width of the recording paper 10 can be aligned with the center of the print area of the print unit 300 by setting this one edge 10b of the recording paper 10 against the face 81a of the first stop 81 and the face 82a of the second stop 82.

The conveyance roller pair 60 holds the center part of the width of the recording paper 10 between the conveyance drive roller 60a and follower roller 60b, and conveys the recording paper 10 in the conveyance direction S. The intersect rollers 70 including the first roller 70a and second roller 70b are disposed so that the position 70c where the first roller 70a and second roller 70b intersect, that is, the position where the recording paper 10 is held by the intersect rollers 70, is between the location of the conveyance roller pair 60 and the location of the guide roller 40. The position 70c where the first roller 70a and second roller 70b intersect is also offset from the center of the recording paper 10 width to the side of the edge 10c on the opposite side as the one edge 10b that is stopped by the guide 80.

As shown in FIG. 2B and FIG. 2C, the intersect rollers 70 hold the recording paper 10 between the first roller 70a and second roller 70b. The first roller 70a is disposed to rotate in direction of rotation R1 and follow the movement of the recording paper 10 in the conveyance direction S of the recording paper 10. The second roller 70b is disposed to rotate freely in direction of rotation R2, which is substantially perpendicular to the direction of rotation in the conveyance direction S of the recording paper 10, that is, the direction of rotation R1 of the first roller 70a.

The first roller 70a is disposed to rotate in the conveyance direction S of the recording paper 10, and the conveyance unit 100 according to this embodiment of the invention urges the recording paper 10 to move in a direction crosswise to the conveyance direction, that is, toward the guide 80 as described below. However, if the frictional resistance between the first roller 70a and recording paper 10 is great, the recording paper 10 may not be reliably urged toward the guide 80. A material with low friction resistance is therefore preferably used on the surface of the first roller 70a that contacts the recording paper 10. Low-cost polyacetal (POM: polyoxymethylene), which is easy to mold and provides structural strength, can be desirably used as a material for the first roller 70a.

Because the second roller 70b is disposed with the axis of rotation aligned with the conveyance direction S of the recording paper 10 and rotates freely in direction of rotation R2 substantially perpendicular to the conveyance direction S of the recording paper 10, the recording paper 10 is conveyed while sliding against the second roller 70b. The surface of the second roller 70b is therefore preferably made from a material with a low coefficient of friction to the recording paper 10 so that the recording paper 10 can slide easily in the conveyance direction S. A fluorocarbon polymer or metal an be used, but stainless steel with excellent wear resistance, corrosion resistance, and strength is particularly preferable.

Note, further, that there are two sets of intersect rollers 70 in this embodiment of the invention, but the invention is not so limited and one or three or more sets could be used depending upon the size of the recording paper 10 and the size of the recording paper support unit 50.

The intersect rollers 70 of the conveyance unit 100 according to this embodiment of the invention are composed of cylindrical first and second rollers, but the invention is not so limited and any rollers that can hold the recording paper 10 therebetween can be used. However, because sliding friction occurs between the second roller 70b and recording paper 10 as described below, the contact area between the second roller and the recording paper 10 is preferably narrow. More specifically, the area in which the recording paper 10 is held between the first roller 70a and second roller 70b is preferably as narrow as possible. As a result, by disposing the first roller 70a and second roller 70b so that the cylindrical surfaces thereof cross each other, variation in the recording paper 10 holding area can be reduced and the recording paper 10 can be conveyed consistently even if there is some deviation in the relative positions of the first roller 70a and second roller 70b due to manufacturing differences.

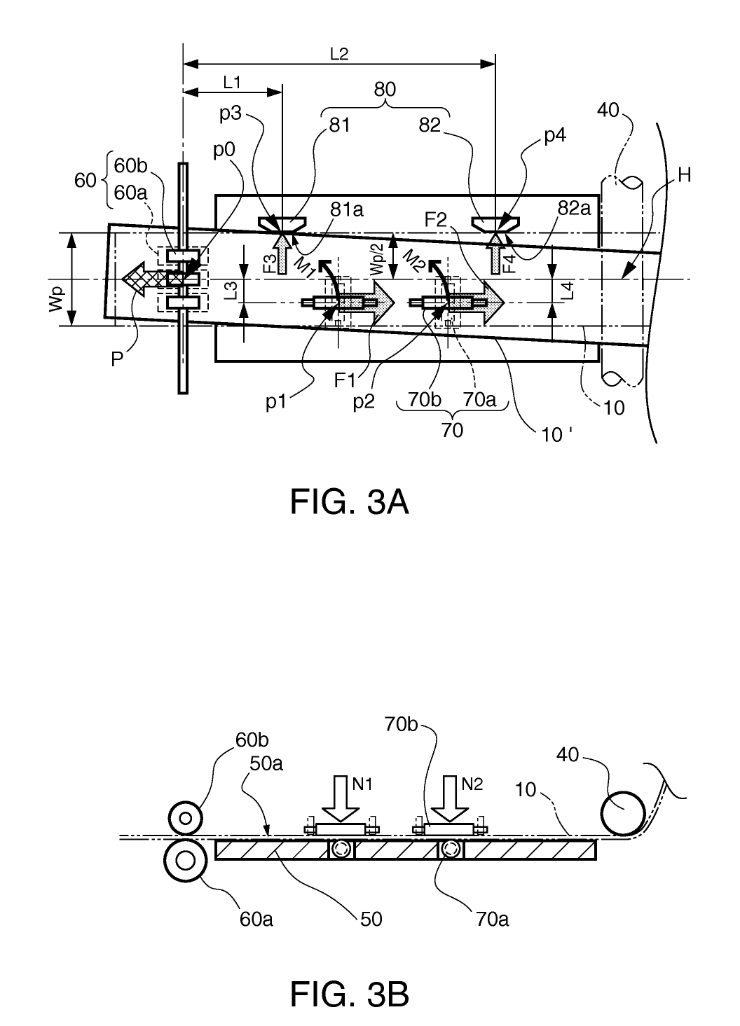

As described above, the recording paper 10 is fed by the paper feed roller 30 (FIG. 1) and is conveyed passed the guide roller 40 while sliding over the recording paper support surface 50a of the recording paper support unit 50. The recording paper 10 is also held by the intersect rollers 70, held by the conveyance roller pair 60, and conveyed to the recording unit 310 of the print unit 300. The operation of the conveyance unit 100 while conveying the recording medium in the printing device 1000 according to this embodiment of the invention is described next with reference to FIG. 3.

FIG. 3A and FIG. 3B further describe the operation of the conveyance unit 100 shown in FIG. 2A and FIG. 2B. The operation whereby skewing of recording paper 10′ that is fed skewed to the desired conveyance direction of the recording paper 10 shown in FIG. 3A is corrected is described below.

As shown in FIG. 3A, the conveyance roller pair 60 is disposed so that the conveyance force P is applied to substantially the center of the width of the recording paper 10 conveyed in the desired conveyance direction. As a result of this configuration, the conveyance force P is applied to substantially the center of the recording paper 10 width, and the recording paper 10 is conveyed toward the print unit 300. If the recording paper 10 is not conveyed in the desired normal conveyance direction, such as when the recording paper 10 becomes skewed and is conveyed from the guide roller 40 as indicated by recording paper 10′ in the figure, recording (printing) to the desired position will not be possible. The conveyance unit 100 according to this embodiment of the invention therefore works as described below to correct the skewed recording paper 10′ to the desired conveyance direction.

The point of application of the conveyance force P applied by the conveyance roller pair 60 to the recording paper 10′ is application point p0. As described above, this application point p0 is positioned substantially on the center line of the recording paper 10 width.

The distances between holding points p1 and p2 where the intersect rollers 70 hold the recording paper 10′ to the line H extending in the conveyance direction through application point p0 are distances L3 and L4.

The distance between the application point p0 and the center p3 of the face 81a of the first stop 81 near application point p0 is L1; and the distance between the application point p0 and the center p4 of the face 82a of the second stop 82 farther from the application point p0 is L2.

Pressure N1, N2 is applied at holding points p1 and p2 where the intersect rollers 70 hold the recording paper 10′, and is the coefficient of friction between the recording paper 10′ and the second roller 70b that rotates in the conveyance direction of the recording paper 10.

As shown in FIG. 3A, the recording paper 10′ conveyed by the conveyance roller pair 60 is held between the intersect rollers 70 and moves while sliding along the second roller 70b. More specifically, friction forces F1, F2 between the second rollers 70b and recording paper 10′ are applied to the recording paper 10′ in the opposite direction as the conveyance direction. Moments M1 and M2 rotating the recording paper 10′ around the application point p0 are produced by means of friction forces F1, F2. Moments M1 and M2 are expressed by the following equations.

M1=F1×L3

M2=F2×L4 (1)

Because friction forces F1, F2 are the forces of friction between the second rollers and the recording paper 10′, they can be expressed as

F1=N1×p

F2=N2×p (2)

and equations (1) can be rewritten as follow.

M1=N1×p×L3

M2=N2×p×L4 (3)

Moments M1, M2 cause the recording paper 10′ to rotate toward the guide 80 and contact faces 81a and 82a. More specifically, the recording paper 10′ is urged to the guide 80 so that one edge of the recording paper 10′ contacts the guide 80, the recording paper 10′ is thereby pushed into the desired conveyance direction, and is conveyed in the direction indicated by recording paper 10 in the figure. The relationship between the contact forces F3, F4 against the faces 81a and 82a, and moments M1 and M2 is shown in equation (4).

M1+M2=F3×L1+F4×L2 (4)

### If N1=N2=Nx, and L3=L4=Lx,

2×Nx×p×Lx=F3×L1+F4×L2 (5)

can be derived from equations (3) and (4).

The recording paper 10′ has a critical load at which force applied along the recording surface to the edge of the recording paper 10′ will cause the edge to buckle and bend, and this critical load is referred to as the bending limit herein. If the bending limit of the recording paper 10′ is F0, contact forces F3, F4 must be less than the bending limit F0, and the relationship shown in equation (6) must be satisfied based on equation (5).

2×Nx××Lx<=(F0×L1+F0×L2)=F0(L1+L2) (6)

The relationship shown in equation (6) is therefore used to optimize the pressure Nx of the second roller 70b of the intersect roller 70, the coefficient of friction determined by selecting the material used for the second rollers 70b, and the locations Lx of the holding points p1 and p2 of the intersect rollers 70. The positions L1, L2 of the faces 81a, 82a of the guides 80 are preferably set to large values based on equation (6), and the difference between L2 and L1 is preferably as great as possible considering the ease of keeping the recording paper 10 correctly aligned with the conveyance direction, and the possibility of the recording paper 10 becoming skewed between the conveyance roller pair 60 and the first stop 81 (in length L1) if L1 is large.

As described above, the conveyance unit 100 according to this embodiment of the invention conveys the recording paper 10 to the print unit 300 with the conveyance roller pair 60 while holding the recording paper 10 between intersect rollers 70 disposed with their axes of rotation crossed. If the recording paper 10 is fed from the paper feed roller 30 and guide roller 40 skewed to the conveyance direction, a moment of rotation centered on the conveyance roller pair 60 is applied to the recording paper 10 by the intersect rollers 70, and the recording paper 10 can be easily corrected to the desired conveyance direction. Because the intersect rollers 70 can be rendered with a simple construction in which both the first roller 70a and second roller 70b are followers, both device reliability and durability can be improved.

While this embodiment has two sets of intersect rollers, the invention is not limited to using two sets, and one or three or more sets can be used if their placement can be designed so that the conveyance direction of the recording paper 10′ can be corrected.

### Embodiment 2

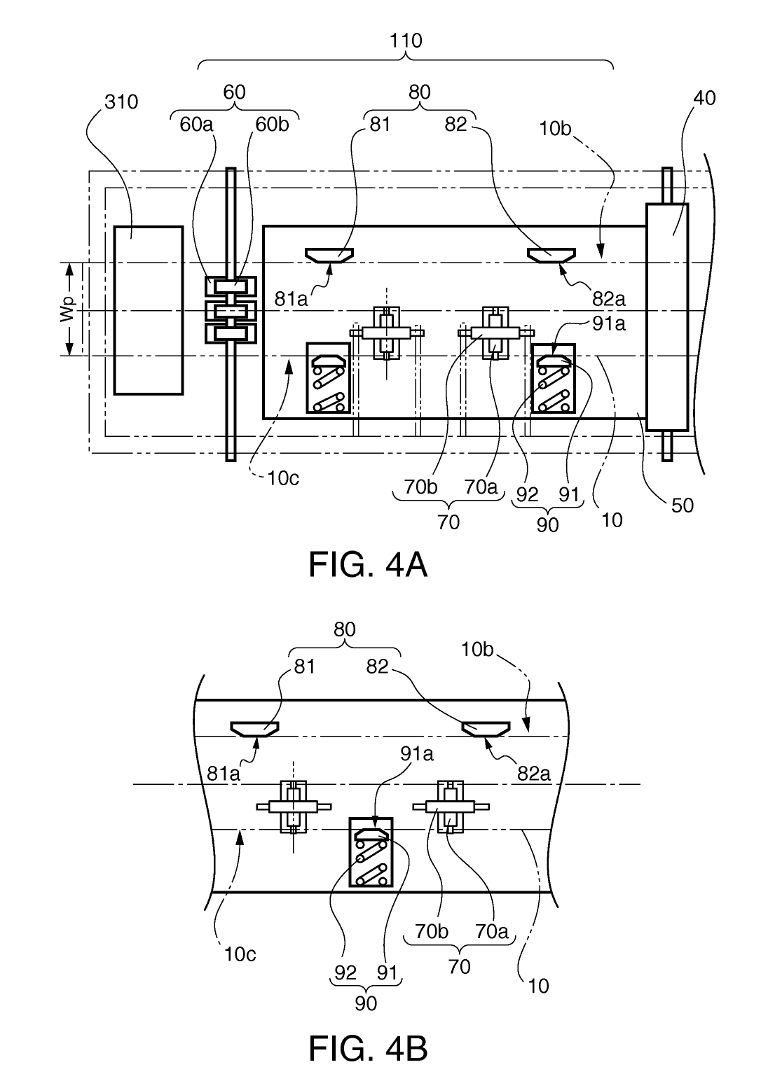

FIG. 4 shows a conveyance unit 110 as an example of a conveyance device according to a second embodiment of the invention. This conveyance unit 110 differs from the conveyance unit 100 of the first embodiment by using an urging unit 90 as an urging means that urges the recording paper 10 to the guide 80. Other aspects are the same as in the conveyance unit 100, identified by like reference numerals, and further description thereof is omitted.

As shown in FIG. 4, the urging unit 90 of the conveyance unit 110 according to the second embodiment of the invention has an urging end 91 with a face 91a that contacts the opposite edge 10c of the recording paper 10 as the edge 10b that contacts the guide 80, and a coil spring 92 as an urging member that urges the urging end 91 towards the guide 80.

The urging unit 90 is disposed to the recording paper support unit 50 movably relative to the width Wp of the recording paper 10 by a position adjusting means not shown, and applies a desirable urging force to the width Wp of the recording paper 10. In the conveyance direction of the recording paper 10, the urging units 90 are preferably disposed opposite the guides 80 with the recording paper 10 therebetween. Alternatively, as shown in FIG. 4B, an urging unit 90 may be disposed to a position midway between the locations of the first stop 81 and second stop 82 of the guide 80. Because the action of controlling the recording paper 10 to the desired conveyance direction can be achieved by the edge 10b of the recording paper 10 contacting the guide 80, the urging unit 90 is preferably disposed to a position where an urging force pushing the recording paper 10 evenly against the first stop 81 and second stop 82 can be applied.

The urging force of the urging unit 90 to the recording paper 10 is applied in addition to the urging force of the intersect rollers 70 urging the recording paper 10 to the guide 80 as described in FIG. 3. The urging force of the urging unit 90 is adjusted so that the urging force combining the urging force of the urging unit 90 to the recording paper 10 and the urging force produced by the intersect rollers 70 is less than the bending limit F0 of the recording paper 10.

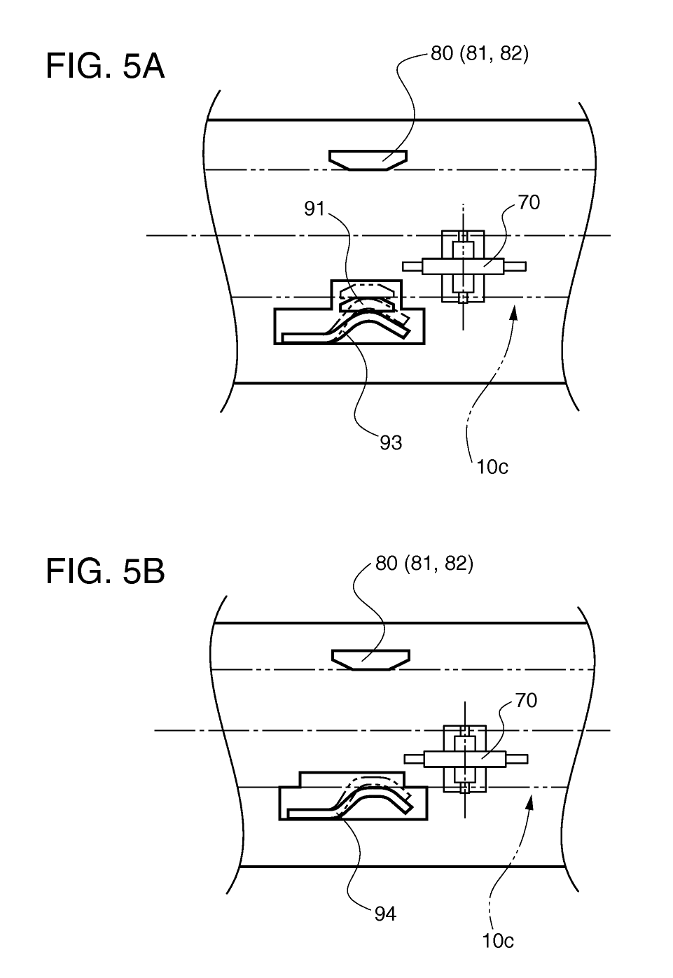

Note that a coil spring 92 is used as an elastic member in the urging unit 90 shown in FIG. 4, but the invention is not so limited. As shown in FIG. 5A, for example, a flat spring 93 that can deflect widthwise to the recording paper 10 can be used to urge the urging end 91, or a flat spring 94 that can deflect widthwise to the recording paper 10 as shown in FIG. 5B could be used to urge the recording paper 10.

The conveyance unit 110 according to the second embodiment of the invention can reliably urge the recording paper 10 to the guide 80 by the urging force of the urging unit 90 in addition to urging the recording paper 10 to the guide 80 by the action of the intersect rollers 70 as described in FIG. 3, and can thus hold the recording paper 10 in the desired conveyance direction.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No: 2011-175650, filed Aug. 11, 2011 is expressly incorporated by reference herein.

What is claimed is:

1. A printing device comprising:
a guide roller that guides a print medium in a conveyance direction;
an intersect roller pair that holds the print medium guided by the guide roller between a first roller that rotates on an axis of rotation in the conveyance direction of the print medium and a second roller that rotates on an axis of rotation that intersects the axis of rotation of the first roller;
a conveyance roller pair that conveys the print medium held by the intersect roller pair in the conveyance direction by a conveyance drive roller driven by a drive mechanism and a conveyance follower roller that rotates with the conveyance drive roller; and
a print unit that prints on the print medium conveyed by the conveyance roller pair.

2. The printing device described in claim 1, further comprising:
a guide that guides one edge of the print medium in the conveyance direction.

3. The printing device described in claim 2, wherein:
the conveyance roller pair is disposed substantially in a center of the print medium width perpendicular to the conveyance direction; and
the intersect roller pair is disposed on a side of the opposite edge of the print medium as the one edge in the conveyance direction.

4. The printing device described in claim 1, further comprising:
a second intersect roller pair that holds the print medium held by the intersect roller pair between a third roller that rotates on an axis of rotation in the conveyance direction of the print medium and a fourth roller that rotates on an axis of rotation that intersects an axis of rotation of the third roller.

5. The printing device described in claim 1, wherein:
the part of the first roller that contacts the print medium is polyacetal, and the part of the second roller that contacts the print medium is stainless steel.

6. The printing device described in claim 2, further comprising:
a pressure mechanism that pushes the print medium to the guide.

7. A conveyance device for a printing device comprising:
an intersect roller pair that holds a conveyed print medium between a first roller that rotates on an axis of rotation in the conveyance direction of the print medium and a second roller that rotates on an axis of rotation that intersects the axis of rotation of the first roller; and
a conveyance roller pair that conveys the print medium held by the intersect roller pair in the conveyance direction by a conveyance drive roller driven by a drive mechanism and a conveyance follower roller that rotates with the conveyance drive roller.

8. The conveyance device for a printing device described in claim 7, further comprising:
a guide that guides one edge of the print medium in the conveyance direction.

9. The conveyance device for a printing device described in claim 8, wherein:
the conveyance roller pair is disposed substantially in a center of the print medium width perpendicular to the conveyance direction; and
the intersect roller pair is disposed on a side of the opposite edge of the print medium as the one edge in the conveyance direction.
